(19) United States
(12) Patent Application Publication
(10) Pub. No.: US 2026/0145369 A1
(43) Pub. Date: May 28, 2026

(54) MOLDING DIE, RESIN MOLDING APPARATUS, AND METHOD FOR PRODUCING RESIN MOLDED PRODUCT

(71) Applicant: TOWA CORPORATION, Kyoto-shi , Kyoto (JP)

(72) Inventor: Toshihiro YAGI, Kyoto-shi, Kyoto (JP)

(21) Appl. No.: 18/878,586

(22) PCT Filed: Jan. 23, 2023
(86) PCT No.: PCT/JP2023/001959

§ 371 Date: Dec. 23, 2024

(30) Foreign Application Priority Data
Jun. 29, 2022 (JP) 2022-104296

(51) Int. Cl. B29C 43/36; B29C 44/58

(52) U.S. Cl. CPC B29C 43/36; B29C 44/588

(57) ABSTRACT

A molding die (1000) includes a first die (200) and a second die (100) disposed so as to face each other, wherein the first die (200) includes a die cavity (204) formed of a space surrounded by a die main surface member (202) serving as a main surface for a bottom or upper surface, and a die side surface member (201) serving as a side surface, the die cavity (204) is capable of storing a resin material (20), the die side surface member (201) is capable of moving up and down relatively to the die side surface member (202), elastic members (203a) and (203b) are disposed on a side of the die side surface member (201) opposite to a side facing the second die (100), so that a pressured state along an outer periphery of a planar shape of the die cavity (204) be partially different.

### TECHNICAL FIELD

The present invention relates to a molding die, a resin molding apparatus, and a method for producing a resin molded product.

### BACKGROUND ART

Compression molding is widely used as one of resin molding methods. As one of its problems, Non Patent Literature 1 describes that a foamable resin material used for compression molding protrudes from a molded product and causes resin leakage.

### CITATION LIST

### Patent Literature

Non Patent Literature 1: Mitsuaki Fusumada et al., “Granule-Type Encapsulating Compound for Compression Molding”, Hitachi Chemical Technical Report No. 61, published in January 2019, PP. 16-17

### SUMMARY OF INVENTION

### Technical Problem

Non-Patent Document 1 describes the occurrence of resin leakage with particulate resin materials, but similar issues of resin leakage could also arise with liquid resin materials that are liquid at normal temperature. In the case using the liquid resin material, the resin leakage occurs due to the viscosity of the heated liquid resin being lowered, the resin being foamed and thus protruding from a gap of a molding die. Compression molding using such a foamable resin material has the first problem that the resin leakage may occur due to the protrusion of the foamable resin material from the gap of the molding die.

It is known to mix the resin material used for compression molding with particulates such as silica, which is called fillers, in order to impart fluidity to the resin material. In recent years, fillers having a small particle diameter have often been used. In the case of performing compression molding using a resin material with small fillers, for example, when exhausting the air in a cavity through an air vent channel of a molding die, the resin may leak out of the cavity. Both of the cases using the particulate resin material and the liquid resin have the second problem that such resin leakage may occur.

The resin material used for compression molding is sometimes mixed with a material which decreases fluidity of the resin, such as magnetic substances. Due to such a material, the resin sometimes does not spread sufficiently in the cavity of the resin molding die, and thus a resin unfilled part is generated. Both of the cases using the particulate resin material and the liquid resin have the third problem that such resin unfilling may occur.

For example, there is a need to prevent a problem of resin leakage or resin unfilling as represented by the above-mentioned first to third problems, to improve productivity.

Hence, it is an object of the present invention to provide a molding die capable of preventing resin leakage or resin unfilling, a resin molding apparatus including the molding die, and a method for producing a resin molded product using the molding die.

### Solution to Problem

To achive the above object, the present invention provides a molding die used for compression molding, including:
a first die, and
a second die, wherein
the first die and the second die are disposed so as to face each other,
the first die includes a die main surface member constituting a main surface as a bottom surface or an upper surface of a die cavity, and a die side surface member constituting a side surface of the die cavity,
the die cavity is formed of a space surrounded by the die main surface member and the die side surface member,
a resin material can be stored in the die cavity, the die side surface member is capable of moving up and down relatively to the die main surface member,
an elastic member is disposed on a side of the die side surface member opposite to a side facing the second die, and
the elastic member is disposed so that a pressured state along an outer periphery of a planar shape of the die cavity be partially different.

The present invention also provides a resin molding apparatus including the molding die of the present invention.

The present invention also provides a method for producing a resin molded product using the molding die of the present invention, including:
supplying the resin material in the die cavity, and
performing resin molding by compression molding using the molding die, after the supplying the resin material, wherein
the performing resin molding includes exhausting air inside the die cavity by making the pressured state along the outer periphery of the planar shape of the die cavity partially different.

### Advantageous Effects of Invention

The present invention can provide a molding die capable of preventing resin leakage or resin unfilling, a resin molding apparatus including the molding die, and a method for producing a resin molded product using the molding die.

### BRIEF DESCRIPTION OF DRAWINGS

FIG. 1 is a plan view (spring arrangement view) showing an example of the arrangement of elastic members when the first die is rectangular.

FIG. 2A is a cross-sectional process view showing an example of the molding die of the present invention, and a method for producing a resin molded product using the molding die in a resin molding apparatus. FIG. 2B is another cross-sectional process view showing an example of the molding die of the present invention, and a method for producing a resin molded product using the molding die in a resin molding apparatus.

FIG. 3A is a cross-sectional process view showing an example of the molding die of the present invention, and a method for producing a resin molded product using the molding die in a resin molding apparatus. FIG. 3B is another cross-sectional process view showing an example of the molding die of the present invention, and a method for producing a resin molded product using the molding die in a resin molding apparatus.

FIG. 4A is a cross-sectional process view showing an example of the molding die of the present invention, and a method for producing a resin molded product using the molding die in a resin molding apparatus. FIG. 4B is another cross-sectional process view showing an example of the molding die of the present invention, and a method for producing a resin molded product the molding die in a resin molding apparatus.

FIG. 5 is a plan view showing an example of the first die of FIGS. 2A and 2B to 4A and 4B.

FIG. 6 is a plan view showing another example of the first die of FIGS. 2A and 2B to 4A and 4B.

FIG. 7A is a cross-sectional view showing an example of air vent channels provided on an upper surface of a side surface member. FIG. 7B is a cross-sectional view showing another example of the air vent channels provided on the upper surface of the side surface member. FIG. 7C is a cross-sectional view showing yet another example of the air vent channels provided on the upper surface of the side surface member.

FIG. 8A is a plan view (spring arrangement view) showing an example of the arrangement of the elastic members when the first die is square. FIG. 8B is a plan view (spring arrangement view) showing another example of the arrangement of the elastic members when the first die is rectangular. FIG. 8C is a plan view (spring arrangement view) showing an example of the arrangement of the elastic members when the first die is circular.

FIG. 9 is a plan view schematically exemplifying a configuration of the entire resin molding apparatus of the present invention.

### DESCRIPTION OF EMBODIMENTS

Hereinafter, the present invention will be described in more detail with reference to examples. However, the present invention is not limited by the following description.

In the present invention, a “molding die” is, for example, a metal die but not limited thereto, and may be, for example, a ceramic die or the like.

In the present invention, the resin molded product is not particularly limited, and may be, for example, a resin molded product obtained by merely molding a resin, or a resin molded product obtained by resin-sealing an electronic element such as a semiconductor chip, a resistance element, and a capacitor element, by resin molding. In the present invention, the resin molded product may be, for example, an electronic component or the like. The electronic component is not particularly limited, and may be any electronic component in which an arbitrary electronic element such as a semiconductor chip, a resistance element, and a capacitor element is resin-sealed. The type, the form, and the like of the electronic element are not particularly limited, and may be, for example, at least one of the above-described various forms (including a flip chip). The resin molded product may also be the one obtained by further resin-sealing an electronic component in which an electronic element such as a semiconductor chip, a resistance element, and a capacitor element is resin-sealed.

In the present invention, a resin material before molding and a resin after molding are not particularly limited, and may be, for example, a thermosetting resin such as an epoxy resin and a silicone resin, or may be a thermoplastic resin. The resin material before molding and the resin after molding may also be a composite material partially containing a thermosetting resin or a thermoplastic resin. In the present invention, examples of a form of the resin material before molding include a particulate resin (including a granular resin), a liquid resin, a sheet-like resin, and a tablet-like resin. Note, that, in the present invention, the liquid resin may be liquid at room temperatures, or may be a molten resin which is melted and becomes liquid by heating. In the present invention, the resin material before molding may be, for example, a foamable resin material.

In the present invention, a “chip” refers to a chip before resin sealing, and specific examples thereof include a chip such as an IC, an LED chip, a semiconductor chip, and a semiconductor element for power control. In the present invention, a chip before resin sealing is referred to as a “chip” for convenience, for distinction from the electronic component after resin sealing. However, the “chip” in the present invention is not particularly limited as long as being a chip before resin sealing, and may not necessarily be chip-like.

In the present invention, a “flip chip” refers to an IC chip having an electrode with bump projections, which is called a bump, as an electrode of a surface of the IC chip (bonding pad), or refers to such a chip configuration. This chip is to be connected to a wiring portion of a printed substrate or the like, in a downward (face-down) state. The flip chip is used, for example, as one type of a chip or a connecting method for wireless bonding.

In the present invention, a molding object for the resin molding is not particularly limited, and may be a substrate, for example. In the present invention, for example, a resin molded product may be produced by resin-sealing (resin-molding) an electronic element (e.g., a semiconductor chip, a resistive element, and a capacitor element) fixed to a substrate (molding object). In the present invention, a substrate (also referred to as an interposer) as the molding object for the resin molding is not particularly limited, and may be for example, a lead frame, a wiring substrate, a wafer, a glass epoxy substrate, a ceramic substrate, a resin substrate, a metal substrate, or the like. The substrate may be, for example, a mounting substrate in which a chip is fixed on a surface of one side or both sides of the mounting substrate. A method for fixing the chip is not particularly limited, and examples thereof include wire bonding and flip-chip bonding. In the present invention, for example, an electronic component with a resin-sealed chip may be produced by resin-sealing a substrate with a chip fixed thereto. Non-limiting examples of the use of the substrate resin-sealed with the resin molding apparatus of the present invention include an LED substrate, a high-frequency module substrate for a portable communication terminal, a module substrate for power control, and a substrate for device control.

The examples of the present invention are described below with reference to the drawings. Each drawing is schematically illustrated by appropriately omitting, exaggerating, and the like for convenience in explanation.

### EXAMPLES

### Example 1

The present example describes an example of the molding die, the resin molding apparatus, and the method for producing a resin molded product according to the present invention.

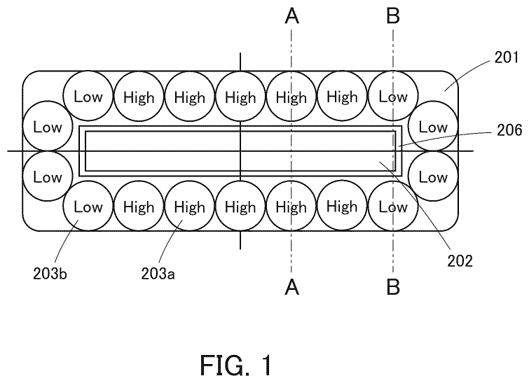

FIG. 1 is a plan view (spring arrangement view) showing an example of the arrangement of elastic members when the first die is rectangular. FIG. 1 shows a side surface member 201 and a main surface member 202 as viewed from the side where elastic members 203 are disposed. As shown in FIG. 1, the elastic members 203 have different heights. An elastic member 203a is high, and an elastic member 203b is low. As shown in FIG. 1, the elastic members 203a and the elastic members 203b are disposed so as to make the pressured state along the outer periphery of the planar shape of the cavity 204 partially different. The elastic member 203a and the elastic member 203b may be disposed, for example, depending on the planar shape of the cavity 204, so that the pressured state be partially different. In FIG. 1 in which the planar shape of the cavity 204 has corner portions and straight-line portions, the elastic members 203b are disposed at the corner portions, and the elastic members 203a are disposed at the straight-line portions (lateral direction in FIG. 1). Particularly in FIG. 1 as the case of rectangle, in parts along the longitudinal direction in the planar shape of the cavity 204 (lateral direction in FIG. 1), the elastic members 203b are disposed at the ends, and the elastic members 203a are disposed at the central portion.

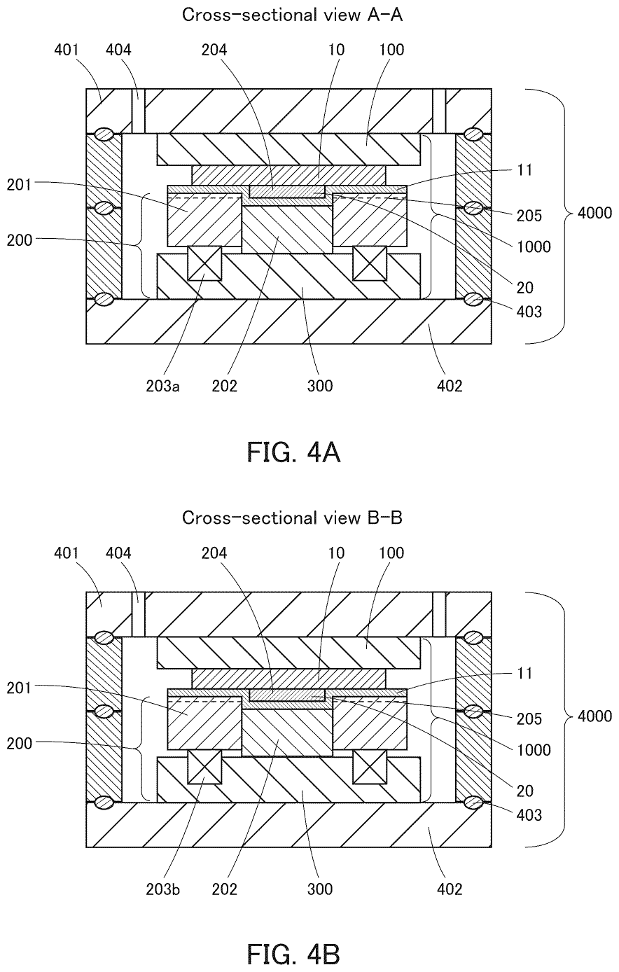

The height of the elastic member 203a and the elastic member 203b may be adjusted, for example, when attaching the elastic member 203a and the elastic member 203b to the molding die of the present aspect, by changing the initial bending amount of the elastic member 203a and the elastic member 203b, or may be adjusted in a state where the elastic member 203b and the elastic member are not expanded or contracted. The height of the elastic member 203a and the elastic member 203b may be adjusted by interposing a spacer in at least one side in a direction of expansion and contraction of the elastic member 203a and the elastic member 203b. In order to make the pressured state along the outer periphery of the planar shape of the cavity 204 partially different, for example, the spring diameter or the spring constant of the elastic member 203a and the elastic member 203b may be changed, instead of changing the height of the elastic member 203a and the elastic member 203b. However, as will be described later, in order to uniformize the pressure applied along the outer periphery of the planar shape of the cavity 204 when clamping of the molding die of the present aspect is completed (see FIG. 4), it is preferable to adjust the height by changing the initial bending amount of the elastic member 203a and the elastic member 203b. Although the height of the elastic member is described with reference to an example of changing the height of the two types of the elastic members in the present aspect, the height of the three or more types of elastic members may be changed. In the case of making the adjustment by changing the spring diameter or the spring constant of the elastic members instead of changing their height, the spring diameter or the spring constant of three or more kinds of elastic members may be changed. Herein, the initial bending amount of the elastic member can be adjusted by changing the contraction amount of the elastic member when attaching the elastic member to the molding die, and can also be expressed as the bending amount of the elastic member in a state before the process of performing resin molding is started. Specifically for example, when setting two types of the initial bending amount, the contraction amount can be set to be two types such as 1 mm and 2 mm, 1 mm and 3 mm, and 2 mm and 3 mm.

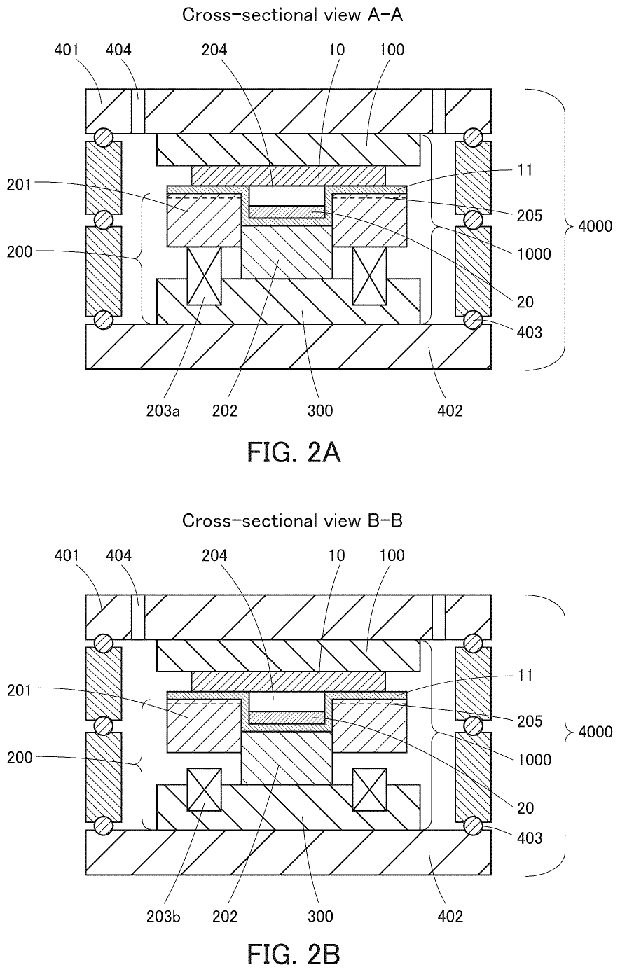

The process cross-sectional views of FIGS. 2A and 2B to 4A and 4B show an example of the molding die of the present example, and a method for producing a resin molded product using the molding die in a resin molding apparatus. Note that, cross-sectional views A-A and cross-sectional views B-B shown in FIGS. 2A and 2B to 4A and 4B show respectively the cross-section A-A and the cross-section B-B in the spring arrangement view of FIG. 1.

As shown in FIGS. 2A and 2B, a molding die 1000 is disposed in an outside air blocking member 4000. The outside air blocking member 4000 is for reducing the pressure inside the outside air blocking member 4000. In order to reduce the pressure inside the outside air blocking member 4000, the resin molding apparatus of the present aspect may further include, for example, an outside air blocking member internal decompression mechanism (not shown). The outside air blocking member internal decompression mechanism is, for example, a vacuum pump. The outside air blocking member 4000 includes a fixed platen 401 and a movable platen 402. An O ring 403 having an elastic force is provided between the fixed platen 401 and the movable platen 402. An upper portion of the fixed platen 401 is provided with a through hole 404 which penetrates the upper portion of the fixed platen 401.

The molding die 1000 includes a first die 200 and a second die 100. The first die 200 includes a side surface member 201 and a main surface member 202. The side surface members 201 are disposed so as to surround the periphery of the main surface member 202. Upper surfaces of the side surface members 201 are provided with air vent channels 205. The cavity 204 is formed of a space surrounded by the side surface members 201 and the main surface member 202. As shown in FIGS. 2A and 2B, a foamable resin material (resin material) 20 can be stored in the cavity 204. Note that, the foamable resin material 20 is a liquid resin in FIGS. 2A and 2B. However, in the present aspect, a form of the foamable resin material 20 before molding is not particularly limited, and may be, for example, a liquid resin, a particulate resin (including a granular resin), a sheet-like resin, a tablet-like resin, or the like, as described above.

The side surface members 201 and the main surface member 202 are disposed on a first die base member 300. The main surface member 202 is directly fixed to an upper surface of the first die base member 300. The side surface members 201 are attached to the upper surface of the first die base member 300 via elastic members 203a. The side surface members 201 can move up and down in accordance with expansion and contraction of the elastic members 203a. The elastic members 203b are further disposed in the first die base member 300. The movable platen 402 is provided below the first die base member 300. The movable platen 402 can raise and lower the first die base member 300.

As shown in FIGS. 2A and 2B, it is possible to attach a substrate (molding object) 10 to a lower surface of the second die 100. The second die 100 is provided to the fixed platen 401 above the second die 100.

A method for producing a resin molded product using the molding die 1000 can be performed as follows, for example. Firstly, the foamable resin material 20 is supplied into the cavity 204. A method for supplying the foamable resin material 20 is not particularly limited, and for example, the foamable resin material 20 may be conveyed to a prescribed position by a resin material conveyance mechanism (not shown) and thereafter supplied into the cavity 204. After the foamable resin material 20 is supplied, the first die 200 and the second die 100 are heated, and the foamable resin material 20 is heated by the heat of the dies. The first die 200 and the second die 100 may be heated in advance, before supplying the resin material.

As shown in FIGS. 2A and 2B, the movable platen 402 is raised in a state where the heated foamable resin material 20 has been supplied into the cavity 204. Thereafter, the inside of the outside air blocking member 4000 is decompressed by the outside air blocking member internal decompression mechanism (not shown). Herein, as shown in FIG. 2A, the elastic members 203a start to bend upon the contact of release films 11 disposed on the side surface members 201 with the substrate 10. Note that, the release films 11 are brought into contact with the substrate 10 at the timing when the foamable resin material 20 does not yet protrude from the cavity 204 of the molding die 1000. Upon the bending of the elastic members 203a, the release films 11 become partially crushed. As shown in FIG. 2B, at this stage, the elastic members 203b are not bent because the side surface members 201 do not contact with the elastic members 203b and thus no force is applied the elastic members 203b. In a state where only the elastic members 203a are bent, the air inside the cavity 204 can be exhausted through the air vent channels 205 even when the release films 11 (side surface members 201) are in contact with the substrate 10. That is, since the release films 11 are in contact with the substrate 10, it is possible to prevent the foamable resin material 20 from leaking from the molding die 1000 even when the foamable resin material 20 is foamed by the reduced pressure. Further, since the air inside the cavity 204 can be sufficiently exhausted even when the release films 11 are in contact with the substrate 10, internal voids of the resin after molding can also be reduced. Note that, as long as the foamable resin material 20 does not yet leak from the molding die 1000, the inside of the outside air blocking member 4000 may be decompressed in a state where the release films 11 disposed on the side surface members 201 are not in contact with the substrate 10. The decompression under the state where the release films 11 are not in contact with the substrate 10 allows faster exhausting of the air inside the cavity 204, compared to the state where the release films 11 are in contact with the substrate 10.

FIGS. 2A and 2B show a state in which the elastic member 203a and the elastic member 203b partially differ the pressured state along the outer periphery of the planar shape of the cavity 204. The description with reference to FIGS. 2A and 2B is a description of the process for exhausting the air inside the cavity 204 by making the pressured state along the outer periphery of the planar shape of the cavity 204 partially different, in the performing resin molding.

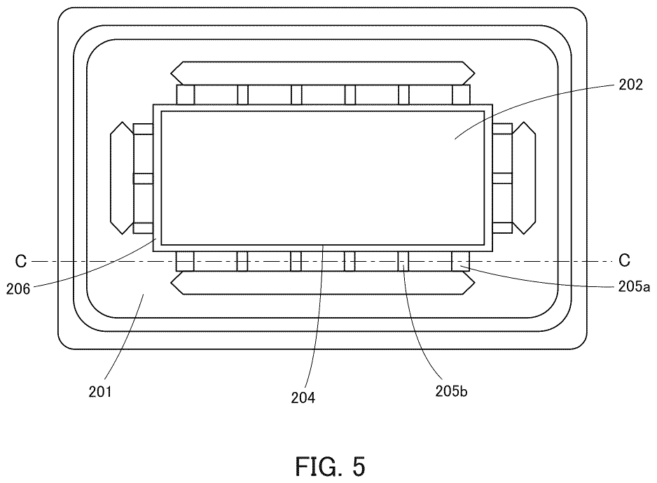

A plan view of the first die in FIG. 5 shows an example of a method for adsorbing the release film 11 onto a die surface of the first die 200. A method for adsorbing the release film 11 may be, for example as shown in FIG. 5, sucking the release film 11 by a suction mechanism (not shown, e.g., a vacuum pump or the like) through a gap 206 (not shown in FIGS. 2A and 2B to 4A and 4B) between the side surface member 201 and the main surface member 202, or an adsorption hole (not shown) formed in the first die, to adsorb the release film 11 onto the die surface of the first die 200. In this way, it is possible to prevent the resin from entering the gap between the side surface member 201 and the main surface member 202 (resin leakage), by covering the die surface of the first die 200 with the release film 11. In addition, the releasability is thus improved.

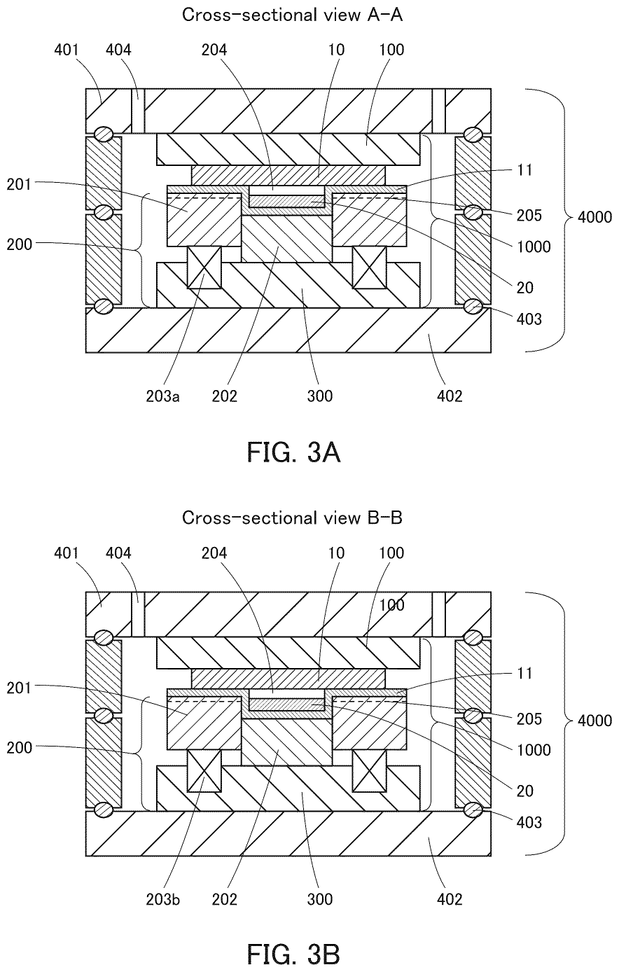

As shown in FIGS. 3A and 3B, when the movable platen 402 is further raised from the state shown in FIGS. 2A and 2B, the elastic members 203b are brought into contact with the side surface members 201, a force is applied to the elastic members 203b, and the elastic members 203b start to bend. Upon the bending of the elastic members 203b, the pressure to the substrate 10 by the release films 11 becomes stronger, so that the exhausting amount from the cavity 204 through the air vent channel 205 becomes smaller. Therefore, conditions of the exhausting are to be set so that the exhausting is sufficiently performed prior to the elastic member 203b starting to bend.

When the movable platen 402 is further raised from the state shown in FIGS. 3A and 3B, the elastic members 203b are sufficiently bent as shown in FIGS. 4A and 4B. At this stage, sufficient resin pressure is applied, and the clamping is completed. After that, the foamable resin material 20 is cured (solidified) to form a cured resin, the first die 200 is lowered to open the mold, and a resin molded product, which is the substrate 10 sealed with the cured resin, is taken out from the molding die 1000. A resin molded product can be produced by performing resin molding in this way. Note that, a method for curing the foamable resin material 20 is not particularly limited. For example, when the foamable resin material 20 is a thermosetting resin, the curing may be performed by heating. When the foamable resin material 20 is a thermoplastic resin, the curing may be performed by cooling or allowing to cool. In FIGS. 2A and 2B to 4A and 4B, the foamable resin material 20 is used as the resin material. However, in the present invention, the resin material is not limited only to the foamable resin material. Further, although nothing is disposed on the surface of the substrate 10 in FIGS. 2A and 2B to 4A and 4B, for example, a chip or the like may be disposed on the surface of the substrate 10. The chip or the like may be resin-sealed (resin-molded) in the performing resin molding, to produce a resin sealed chip as an electronic component (resin molded product).

Note that, in the first die 200, the depth of the cavity 204 before the clamping (state where the elastic member 203a and the elastic member 203b are not expanded or contracted) is not particularly limited and may be, for example, 1 mm or more, 3 mm or more, 5 mm or more, or 10 mm or more, and for example, 30 mm or less, 20 mm or less, 10 mm or less, 5 mm or less, or 3 mm or less. The depth of the cavity 204 after the clamping (state in FIGS. 4A and 4B) is not particularly limited and may be, for example, 1 mm or more, 3 mm or more, 5 mm or more, 10 mm or more, or 15 mm or more, and for example, 20 mm or less, 10 mm or less, 5 mm or less, 3 mm or less, or 1 mm or less. The depth of the cavity 204 after the clamping is almost equal to the resin thickness (package thickness) of the resin molded product after the molding.

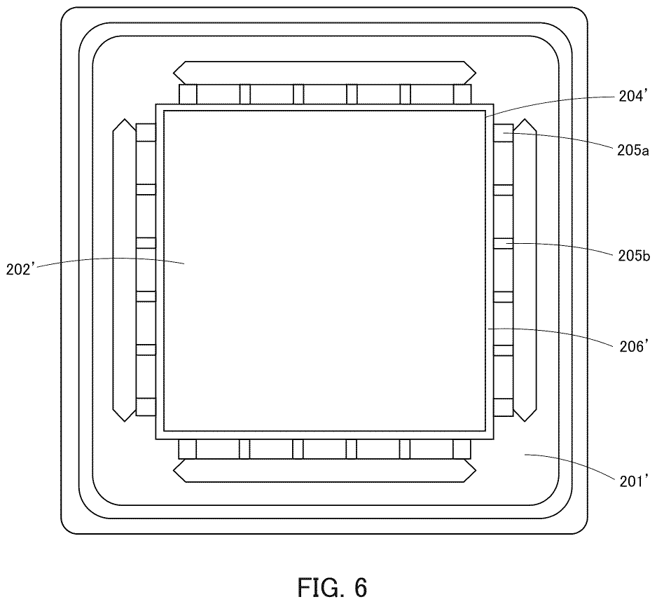

A shape of the first die 200 is not particularly limited and may be, for example, rectangular as shown in FIG. 5, or square as shown in FIG. 6. The first die 200 may also be circular, but not shown.

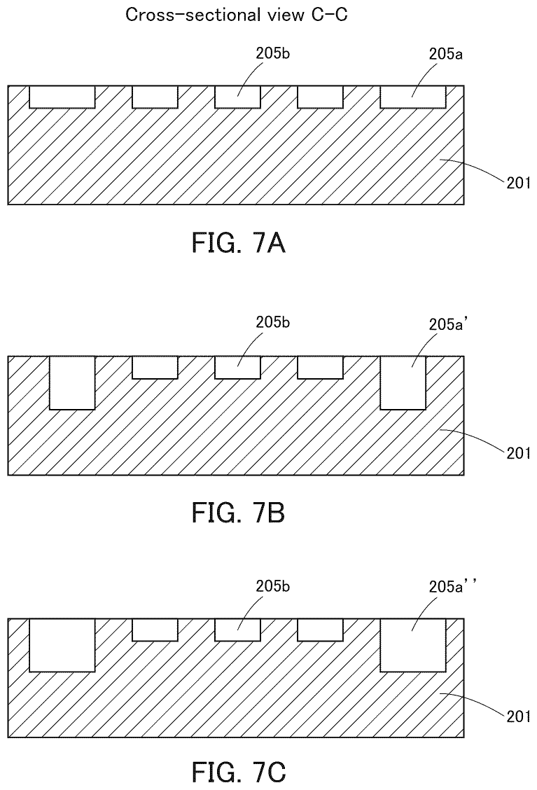

In FIG. 5, the air vent channels 205 are provided on the side surface member 201 so as to surround the cavity 204 (main surface member 202). Herein, among the air vent channels 205 provided along the longitudinal direction (lateral direction in FIG. 5) of the cavity 204, the ones located at the most ends in the longitudinal direction of the cavity 204 have a shape different from the ones closest to the center position (the air vent channel 205a and the air vent channel 205b). In FIG. 5, the width of the air vent channel 205a in the longitudinal direction of the cavity 204 is larger than the width of the air vent channel 205b in the longitudinal direction of the cavity 204, but the configuration is not limited thereto. Between the air vent channel 205a and the air vent channel 205b, for example, only the width (lateral direction in FIGS. 7A to 7C) may be changed (FIG. 5, FIG. 7A), only the depth (vertical direction in FIGS. 7A to 7C) may be changed (FIG. 7B), or both the width and the depth may be changed (FIG. 7C). That is, the cross-sectional area of the air vent channel 205a may be larger than that of the air vent channel 205b. The exhausting amount from the cavity 204 can be easily adjusted, by adjusting the cross-sectional area of the air vent channels. Further, the foamable resin material 20 supplied into the cavity 204 has fluidity. When the planar shape of the cavity 204 is rectangular, the corner portions of the rectangle tend to be unfilled with resin. This is considered to be because, for example, the foamable resin material 20 flows outward from the inner part of the cavity 204, so that the resin does not sufficiently spread to the corner portions. Therefore, by making the cross-sectional area of the air vent channels 205a located at the most ends in the longitudinal direction of the cavity 204 larger than that of the air vent channels 205b closest to the center position, it is possible to allow the resin to sufficiently reach the corner portions by the exhausting of the air (deaeration) inside the cavity 204.

FIG. 6 shows the arrangement of the air vent channels 205 when the first die 200 is square. Similarly to FIG. 5, the air vent channels 205 are provided on the side surface member 201′ so as to surround the cavity 204′ (main surface member 202′). The cross-sectional area of the air vent channel 205a is larger than that of the air vent channel 205b. Herein, when the first die 200 is square, the four sides of the cavity 204′ have the same length. In this case, the air vent channels 205a are preferred to be provided at positions close to the four corners (corner parts) of the cavity 204′.

When the first die 200 is circular (not shown), it is preferred to provide a plurality of air vent channels radially so as to surround the circular cavity, for example. In this case, the number of the air vent channels can be appropriately selected according to the size of the cavity.

When the shape of the first die 200 is the shape of FIG. 5 (rectangle), for example, the elastic member 203a and the elastic member 203b can be disposed as shown in FIG. 1. As described above, it is not easy for the foamable resin material to sufficiently spread over the corner portions of the cavity. Therefore, for example, the exhausting efficiency through the air vent channel 205a is improved by providing the elastic member 203b below the air vent channel 205a, and letting the air vent channel 205a to be pressured with less degree than the air vent channel 205b at the stage of the exhausting shown in FIGS. 2A and 2B.

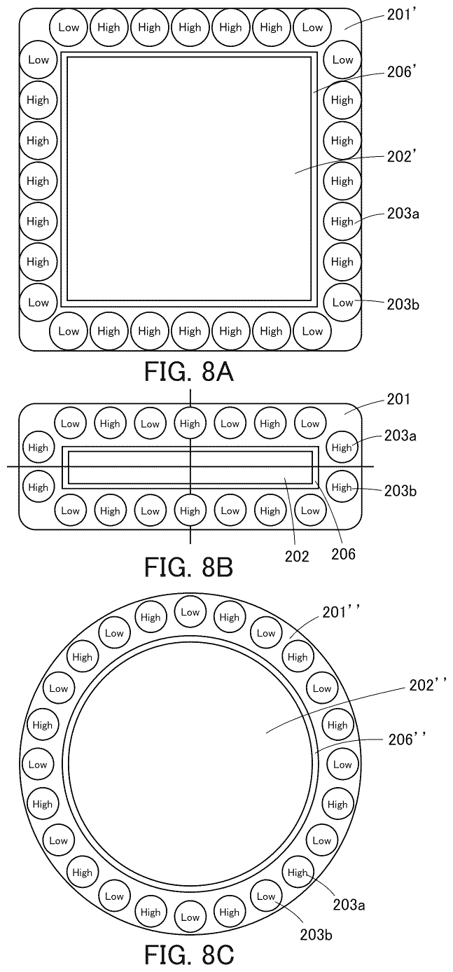

When the shape of the first die 200 is the shape of FIG. 6 (square), for example, the elastic member 203a and the elastic member 203b can be disposed as shown in FIG. 8A. Similarly to the case where the first die 200 is rectangular, the exhausting efficiency through the air vent channel 205a is improved by providing the elastic member 203b below the air vent channel 205a, and letting the air vent channel 205a to be pressured with less degree than the air vent channel 205b at the stage of the exhausting shown in FIG. 2.

The elastic member 203a and the elastic member 203b may be disposed alternately as shown in FIGS. 8B and 8C, for example. In this case, for example, the air vent channel 205b may be provided above the elastic member 203a, and the air vent channel 205a may be provided above the elastic member 203b.

Note that, described above is an example where a foamable resin material is used as the resin material. When a foamable resin material is used as the resin material, application of the present invention allows prevention of the resin leakage due to the protrusion of the foamable resin material from the gap of the molding die.

As the resin material, a resin material mixed with fillers having a relatively small particle diameter may be used. In this case, the timing of bringing the release film 11 into contact with the substrate 10 described with reference to FIGS. 2A and 2B may be set regardless of the timing of protrusion of the resin due to foaming. Even when using the resin material mixed with filers having a relatively small particle diameter as the resin material, application of the present invention allows the prevention of the resin leakage. As the filler, for example, a particulate material made of silica can be used.

As the resin material, a resin material mixed with a material which decreases fluidity may be used. In this case, the timing of bringing the release film 11 into contact with the substrate 10 described with reference to FIGS. 2A and 2B may be set regardless of the timing of protrusion of the resin due to foaming. When using the resin material mixed with a material which decreases fluidity as the resin material, even if the fluidity of the resin is decreased, application of the present invention can realize the exhausting in a state where the release film 11 is in contact with the substrate 10, promoting the spreading of the resin in the cavity 204, and thereby preventing the occurrence of a resin unfilled portion. Examples of the material which decreases the fluidity include magnetic substances.

### Example 2

The present example describes an example of the entire configuration of the resin molding apparatus of the present invention, and a method for producing a resin molded product using the resin molding apparatus.

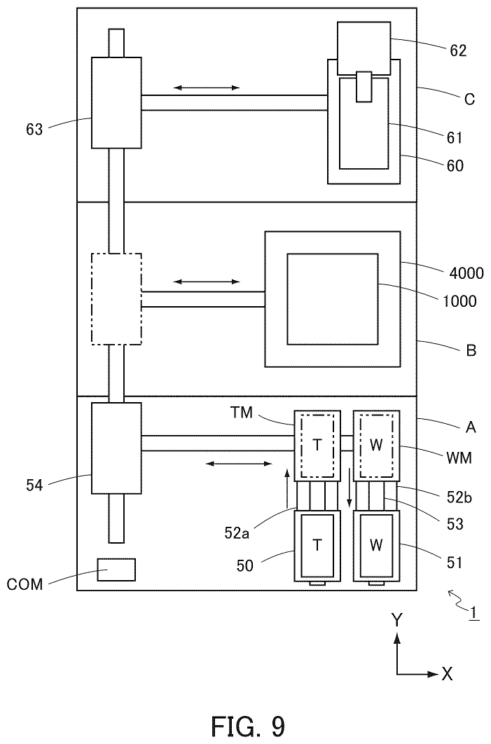

As shown in FIG. 9, the resin molding apparatus 1 includes a substrate supply and storage module A, a resin molding module B, and a resin material supply module C as components. Each of the components (each module A to C) are removable and replaceable interchangeably with each other.

The substrate supply and storage module A includes a substrate supply unit 50, a substrate storage unit 51, conveyance paths 52a and 52b, an inspection device 53, a substrate conveyance mechanism 54, a substrate mounting unit TM, a molded substrate mounting unit WM, and a control unit COM. The substrate supply unit 50 supplies the substrate 10 as a resin molding object before molding. The conveyance path 52a is used to convey the substrate 10 supplied from the substrate supply unit 50, in a Y direction. The substrate 10 conveyed through the conveyance path 52a is mounted on the substrate mounting unit TM.

The substrate conveyance mechanism 54 receives the substrate 10 mounted on the substrate mounting unit TM from a moving mechanism (not shown) which is movable in the Y direction, moves in a X direction and the Y direction in the substrate supply and storage module A and the resin molding module B, and conveys the substrate 10 to the molding die 1000 of the resin molding module B. Further, the substrate conveyance mechanism 54 moves in the X direction and the Y direction in the substrate supply and storage module A and the resin molding module B, receives a resin molded substrate W (resin molded product) resin-molded in the molding die 1000 of the resin molding module B, and conveys the resin molded substrate W (resin molded product) to the substrate supply and storage module A.

On the molded substrate mounting unit WM, the resin molded substrate W moved from the substrate conveyance mechanism 54 is mounted by a moving mechanism (not shown) which is movable in the Y direction. The conveyance path 52b is used to convey the resin molded substrate W mounted on the molded substrate mounting unit WM, in the Y direction.

As one example, the conveyance paths 52a and 52b may be formed of a pair of rails in which a groove portion having a C-shaped cross section is formed, and the openings of the groove portions are disposed so as to face each other. In the case of this example, the substrate 10 or the resin molded substrate W can be disposed, so as the end portion of the substrate 10 or the resin molded substrate W fits in the groove portion of the rail, to be slid along the rail in the longitudinal direction of the rail (corresponding to the Y direction in FIG. 9).

The inspection device 53 inspects the appearance of the resin molded substrate W which is moved from the molded substrate mounting unit WM and being conveyed in the conveyance path 52b. The substrate storage unit 51 stores the resin molded substrate W conveyed from the conveyance path 52b.

The control unit COM includes CPU (Central Processing Unit), RAM (Random Access Memory), ROM (Read Only Memory), and the like, and is configured to control the respective components according to information processing. The control unit COM is configured to control at least the inspection device 53, and may be configured to control the entire resin molding apparatus 1.

The resin molding module B is a resin molding unit for molding a resin on the substrate 10, and includes the molding die 1000 and the outside air blocking member 4000. The resin molding module B uses the foamable resin material 20 supplied by the resin material supply unit C to produce the resin molded substrate W (resin molded product) by a compression molding method.

The molding die 1000 for compression molding may be, for example, the one including the second die 100 and the first die 200 disposed so as to face each other, where the substrate 10 is supplied to the second die 100, and the foamable resin material 20 is supplied to the first die 200. In the case of this example, the first die 200 may be the one including the main surface member 202 constituting a main surface as the bottom surface or the upper surface of the cavity 204, and the side surface member 201 constituting the die cavity side surface, where the main surface member 202 and the side surface member 201 are relatively slidable.

The resin material supply module C includes a moving table 60, a resin material storage unit 61 to be mounted on the moving table 60, a resin material supply unit 62 for supplying the foamable resin material 20 to the resin material storage unit 61, and a resin material conveyance mechanism 63 which conveys the resin material storage unit 61 and supplys the foamable resin material 20 to the molding die 1000 of the resin molding module B. The moving table 60 is configured to move in the X direction and the Y direction in the resin material supply module C. The resin material conveyance mechanism 63 moves in the X direction and the Y direction in the resin material supply module C and the resin molding module B. The resin material conveyance mechanism 63 conveys the resin material storage unit 61 storing the foamable resin material 20 to the molding die 1000 to supply the foamable resin material 20. As one example, the resin material storage part 61 may be configured by disposing a release film so as to close the lower opening of a frame-shaped member.

The present invention is not limited to the above-described examples. Various combination, changes, and selections may be made freely and appropriately in the configuration and specifics of the present invention without departing from the scope of the present invention.

### Supplementary Notes

The whole or part of the example embodiments disclosed above can be described as, but not limited to, the following supplementary notes.
(Supplementary Note 1)

A molding die used for compression molding, including:
a first die, and
a second die, wherein
the first die and the second die are disposed so as to face each other,
the first die includes a die main surface member constituting a main surface as a bottom surface or an upper surface of a die cavity, and a die side surface member constituting a side surface of the die cavity,
the die cavity is formed of a space surrounded by the die main surface member and the die side surface member,
a resin material can be stored in the die cavity,
the die side surface member is capable of moving up and down relatively to the die main surface member,
an elastic member is disposed on a side of the die side surface member opposite to a side facing the second die, and
the elastic member is disposed so that a pressured state along an outer periphery of a planar shape of the die cavity be partially different.
(Supplementary Note 2)

The molding die according to Supplementary Note 1, wherein with respect to the elastic member, there are two types of elastic members having an initial bending amount different from each other.
(Supplementary Note 3)

The molding die according to Supplementary Note 1 or 2, wherein
the resin material stored in the die cavity is a foamable resin material.
(Supplementary Note 4)

The molding die according to any one of Supplementary Notes 1 to 3, wherein
the elastic member is disposed so that the pressured state be partially different depending on the planar shape of the die cavity.
(Supplementary Note 5)

The molding die according to any one of Supplementary Notes 1 to 4, wherein
the planar shape of the die cavity has a corner portion and a straight-line portion, and
the elastic member is disposed so that pressure applied to a part corresponding to the corner portion be smaller than pressure applied to a part corresponding to the straight-line portion.
(Supplementary Note 6)

The molding die according to any one of Supplementary Notes 1 to 5, wherein
two sides of the planar shape of the die cavity which cross each other at right angles have different lengths, and
the elastic member is disposed so that, in a part along a longitudinal direction in the planar shape, pressure applied to an end be smaller than pressure applied to a central portion.
(Supplementary Note 7)

The molding die according to any one of Supplementary Notes 1 to 6, wherein
an air vent channel is formed in the die side surface member.
(Supplementary Note 8)

The molding die according to Supplementary Note 6, wherein
an air vent channel is formed in the die side surface member, and
in the part along the longitudinal direction, a cross-sectional area of the air vent channel at a most end is larger than a cross-sectional area of the air vent channel closest to a central position.
(Supplementary Note 9)

The molding die according to Supplementary Note 6, wherein
an air vent channel is formed in the die side surface member, and
in the longitudinal direction, a width in the longitudinal direction of the air vent channel at a most end is larger than a width in the longitudinal direction of the air vent channel closest to a central position.
(Supplementary Note 10)

A resin molding apparatus, including
the molding die according to any one of Supplementary Notes 1 to 9.
(Supplementary Note 11)

A method for producing a resin molded product using the molding die according to any one of Supplementary Notes 1 to 9, including:
supplying the resin material in the die cavity, and
performing resin molding by compression molding using the molding die, after the supplying the resin material, wherein
the performing resin molding includes exhausting air inside the die cavity by making the pressured state along the outer periphery of the planar shape of the die cavity partially different.

This application claims priority from Japanese Patent Application No. 2022-032709filed on Jun. 29, 2022. The entire subject matter of the Japanese Patent Application is incorporated herein by reference.

### REFERENCE SIGNS LIST

1 Resin molding apparatus
10 Substrate before sealing (substrate)
11 Release film
20 Foamable resin material (resin material)
50 Substrate supply unit
51 Substrate storage unit
52a, 52b Conveyance path
53 Inspection device
54 Substrate conveyance mechanism
60 Moving table
61 Resin material storage unit
62 Resin material supply unit
63 Resin material conveyance unit
100 Second die
200 First die
201, 201′, 201″ Side surface member
202, 202′, 202″ Main surface member
203a, 203b Elastic member
204, 204′ Cavity
205a, 205a′, 205a″, 205b Air vent channel
206, 206′, 206″ Gap
300 First die base member
401 Fixed platen
402 Movable platen
403 O ring
404 Through hole
1000 Molding die
4000 Outside air blocking member
A Substrate supply and storage module
B Resin molding module
C Resin material supply module
TM Substrate mounting unit
WM Molded substrate mounting unit
W Resin molded substrate (resin molded product)
COM Control unit

1. A molding die used for compression molding, comprising:
a first die, and
a second die, wherein
the first die and the second die are disposed so as to face each other,
the first die includes a die main surface member constituting a main surface as a bottom surface or an upper surface of a die cavity, and a die side surface member constituting a side surface of the die cavity,
the die cavity is formed of a space surrounded by the die main surface member and the die side surface member,
a resin material can be stored in the die cavity,
the die side surface member is capable of moving up and down relatively to the die main surface member,
an elastic member is disposed on a side of the die side surface member opposite to a side facing the second die, and
the elastic member is disposed so that a pressured state along an outer periphery of a planar shape of the die cavity be partially different.

2. The molding die according to claim 1, wherein
with respect to the elastic member, there are two types of elastic members having an initial bending amount different from each other.

3. The molding die according to claim 1, wherein the resin material stored in the die cavity is a foamable resin material.

4. The molding die according to claim 1, wherein
the elastic member is disposed so that the pressured state be partially different depending on the planar shape of the die cavity.

5. The molding die according to claim 1, wherein
the planar shape of the die cavity has a corner portion and a straight-line portion, and
the elastic member is disposed so that pressure applied to a part corresponding to the corner portion be smaller than pressure applied to a part corresponding to the straight-line portion.

6. The molding die according to claim 1, wherein
two sides of the planar shape of the die cavity which cross each other at right angles have different lengths, and
the elastic member is disposed so that, in a part along a longitudinal direction in the planar shape, pressure applied to an end be smaller than pressure applied to a central portion.

7. The molding die according to claim 1, wherein
an air vent channel is formed in the die side surface member.

8. The molding die according to claim 6, wherein
an air vent channel is formed in the die side surface member, and
in the part along the longitudinal direction, a cross-sectional area of the air vent channel at a most end is larger than a cross-sectional area of the air vent channel closest to a central position.

9. The molding die according to claim 6, wherein
an air vent channel is formed in the die side surface member, and
in the longitudinal direction, a width in the longitudinal direction of the air vent channel at a most end is larger than a width in the longitudinal direction of the air vent channel closest to a central position.

10. A resin molding apparatus, comprising
the molding die according to claim 1.

11. A method for producing a resin molded product using the molding die according to claim 1, comprising:
supplying the resin material in the die cavity, and
performing resin molding by compression molding using the molding die, after the supplying the resin material, wherein
the performing resin molding includes exhausting air inside the die cavity by making the pressured state along the outer periphery of the planar shape of the die cavity partially different.
